(19) United States
(12) Patent Application Publication
(10) Pub. No.: US 2005/0093296 A1
(43) Pub. Date: May 5, 2005

(54) An Upset Downhole Component

(76) Inventors: David R. Hall, Provo, UT (US); Joe Fox, Spanish Fork, UT (US)

Correspondence Address: JEFFREY E. DALY;GRANT PRIDECO, L.P., 400 N. SAM HOUSTON PARKWAY EAST, SUITE 900, HOUSTON, TX, 77060, US

(21) Appl. No.: 10/605,867

(22) Filed: Oct. 31, 2003

(51) Int. Cl. F16L 13/02

(52) U.S. Cl. 285/288.1

(57) ABSTRACT

A downhole component comprising a tube comprising an upset adapted for the passage of a transmission line. The tube of the downhole component further comprises an inside diameter, and the downhole component further comprises an elongate, generally cylindrical tool joint comprising a wall and a first interfacial surface. The upset is formed on an end of the tube and comprises a second interfacial surface and an effective inside diameter less than the inside diameter of the tube. The tool joint is attached to the upset on the tube at the first and second interfacial surfaces, and an opening formed within the wall of the tool joint is aligned with a passageway formed in the upset. The opening and the passageway cooperate to allow passage of a transmission line between the tool joint and the tube. The passageway in the upset may be formed at the time the upset is formed or afterwards.

### FEDERAL RESEARCH STATEMENT

This invention was made with government support under Contract No. DE-FC26-97FT343656 awarded by the U.S. Department of Energy. The government has certain rights in the invention.

### BACKGROUND OF INVENTION

This invention relates to a downhole component comprising an upset tube and a tool joint. More particularly this invention relates to an upset in the tube adapted for the passage of a transmission line from the tool joint to the upset tube before the tool joint is attached to the upset tube. The tool joint comprises an opening that is aligned with a passageway formed in the upset portion of the tube that allows the passage of the transmission line which is connected to transmission couplers positioned within the tool joints at one or both ends of the component.

In order to provide a downhole tool component capable of being adapted for transmission of an electronic signal along a drill string, a pathway must be provided within downhole tool between the tubular portion of the downhole tool component and the tool joint attached to the downhole tube.

High strength downhole tubes are usually manufactured with upset ends. Examples of the manufacturing process for upsetting the ends of downhole tube may be found in U.S. Pat. No. 5,743,301, to Winship; U.S. Pat. No. 5,517,843, to Winship; U.S. Pat. No. 5,361,846, to Carlin et al.; and U.S. Pat. No. 5,184,495, to Chunn et al., all incorporated by reference herein for what they teach and disclose.

In modern downhole tool making, the upset tube is attached to the tool joint by friction welding, spin welding, or inertial welding. An example of the process for attaching the upset tube to the tool joint may be found in U.S. Pat. No. 4,151,018, to Bolton, incorporated incorporated by reference herein for what it teaches and discloses.

Examples of adapting a tool joint for passage of a transmission line are found in U.S. Pat. No. 3,170,137 to Brandt; U.S. Pat. No. 3,879,097, to Oertle; U.S. Pat. No. 4,445,734 to Cunningham; U.S. Pat. No. 4,884,071 to Howard; and U.S. Pat. No. 4,095,865, to Denison et al., all incorporated by reference herein for what they teach and disclose. Although no detail in provided in the cited references regarding the method used to provide the openings in the tool joints, it may be presumed that some sort of boring operation was used. However, the constraints of the tool joint make very difficult and expensive to bore openings in the tool joint, and it is especially difficult of produce directional openings.

Therefore, what is needed is to provide a downhole component comprising an upset tube and a tool joint, the upset tube being adapted for passage of the transmission line prior to its attachment to the tool joint, thereby facilitating manufacturing and reducing the costs of the downhole component.

### SUMMARY OF INVENTION

This disclosure presents a downhole component such as a drill pipe or other useful tool in drilling oil, gas, and geothermal wells. An object of this invention is to facilitate the use of a transmission line in the downhole tool. While the downhole component comprises a tube having tool joints at each end, an object of this invention is to provide an upset tube configured in cooperation with the tool joints to permit the passage of a transmission line through the tube, thereby connecting transmission couplers located in the respective tool joints. This objective is achieved in part by the alignment of an opening in the tool joints with the passageway in the upset portion of the tube ends. The transmission line may then be directed through the opening in the tool joints and through the passageway in the upset portion of the tube, thereby connecting the transmission couplers located in the tool joints with each other. In this manner, an electrical signal may be transmitted from one end of the tool to the other and across the tool joint connection to the adjacent tool, in series, from one end of the drill string to the other.

The downhole component comprises transmission couplers and a transmission line which are part of a downhole network for electrical transmission between downhole equipment and surface equipment. The downhole component comprises a tube comprising an upset end adapted for the passage of a transmission line. The tube is selected from the group consisting of downhole tools that make up a drill string consisting of drill pipe, heavyweight drill pipe, sub-assemblies, drill collars, drill bits, drill motors, logging while drilling tools, hole openers, stabilizers, under-reamers, rotary steerable systems, drilling jars, drilling shock absorbers, drilling turbines, sensor packages, and measuring while drilling tools.

The tube of the downhole component further comprises an inside diameter. The tool joint comprises an elongate, generally cylindrical tool joint consisting of either a pin end tool joint or a box end tool joint. The tool joint comprises a wall and a first interfacial surface. The upset is formed on an end of the tube and comprises a second interfacial surface and an effective inside diameter less than the inside diameter of the tube. The tool joint is attached to the upset on the tube at the first and second interfacial surfaces, respectively. An opening formed within the wall of the tool joint is aligned with a passageway formed in the upset. When the tool joint is joined with the upset tube, the opening and the passageway cooperate to allow passage of the transmission line between the tool joint and the tube.

The passageway in the upset may be formed at the time the upset is formed in the tube or afterwards by forging or machine technology. The passageway formed in the upset end of the tube should be constrained according to the design of the tube and the tool joint and preferably does not infringe the effective diameter of the upset portion of the tube nor require that a standard downhole tool be downgraded by its presence. Embodiments of the upset passageway may comprise a variety of shapes that will cooperate with the opening in the tool joint to permit passage of the transmission line. They include, but are not limited to, an upset having a wall of varying thickness; an upset having an effective diameter eccentric from the longitudinal axis of the tube and tool joint; an upset having a wall thickness that is less than the tool joint bore wall thickness at a first interfacial surface in the tool joint and at a second interfacial surface in the upset; an upset having a circumferential groove in a portion of the upset; an upset having spiral groove; an upset having an axial groove in at least a portion of the upset; an upset comprising an internal passageway intersecting the second interfacial surface and the transition surface of the upset; and an upset having one or more external passageways intersecting the second interfacial surface, the bore wall of the upset, and the transition surface of the upset. In some embodiments it may be beneficial to provide different upset configuration in the same tool in order to accommodate the design of the downhole tool and its application.

Generally, the tool joint is joined to the upset portion of the tube at first and second interfacial surfaces, respectively. Friction, or inertial, welding is the preferred method of attachment. In some cases, the method of attachment produces an obstruction at the interface which must be removed before installation of the transmission line.

### BRIEF DESCRIPTION OF DRAWINGS

FIG. 1 is a cross section view of a drill rig drilling a borehole into the earth using a downhole component of the present invention.

FIG. 2 is a perspective diagram of a downhole tube comprising upset ends.

FIG. 3 is a cross-section diagram of FIG. 1.

FIG. 4 is a cross-section diagram of downhole tube comprising upset ends depicting placement of the tool joints at interfacial surfaces.

FIG. 5 is a cross-section diagram of an embodiment of the present invention depicting an upset end comprising an internal passageway.

FIG. 5a is an end view the embodiment of FIG. 5.

FIG. 6 is a cross-section diagram of an embodiment of the present invention depicting an upset end comprising an external passageway.

FIG. 6a is an end view the embodiment of FIG. 6.

FIG. 7 is a cross-section diagram of an embodiment of the present invention depicting an upset end comprising a spiral passageway.

FIG. 7a is an end view the embodiment of FIG. 7.

FIG. 8 is a cross-section diagram of an embodiment of the present invention depicting an upset end comprising a circumferential groove or chamfer passageway.

FIG. 8a is an end view the embodiment of FIG. 8.

FIG. 9 is a cross-section diagram of an embodiment of the present invention depicting an upset end comprising an eccentric wall thickness passageway.

FIG. 9a is an end view the embodiment of FIG. 9.

FIG. 10 is a cross-section diagram of an embodiment of the present invention depicting an upset end comprising a varying wall thickness passageway.

FIG. 10a is an end view the embodiment of FIG. 10.

FIG. 11 is a cross-section diagram of an embodiment of the present invention depicting an upset end comprising an upset wall thickness that is less than the wall thickness of the tool joint to which it is attached.

### DETAILED DESCRIPTION

This invention presents a downhole tube having upset ends adapted for the passage of a transmission line. An objective of the invention is to provide a downhole component 6, 8, 10, 12 comprising an upset tube and tool joint that cooperate with each other to allow the passage of a transmission line from one end of the downhole component to the other. The transmission line is connected to transmission couplers located in the tool joints, thereby providing a means for transmitting an electronic signal from one end of the downhole component 6, 8, 10, 12 to the other. The downhole component 6, 8, 10, 12 is a part of a downhole network for transmitting power and data between downhole equipment and surface equipment. The invention will be further described in relation to the following figures.

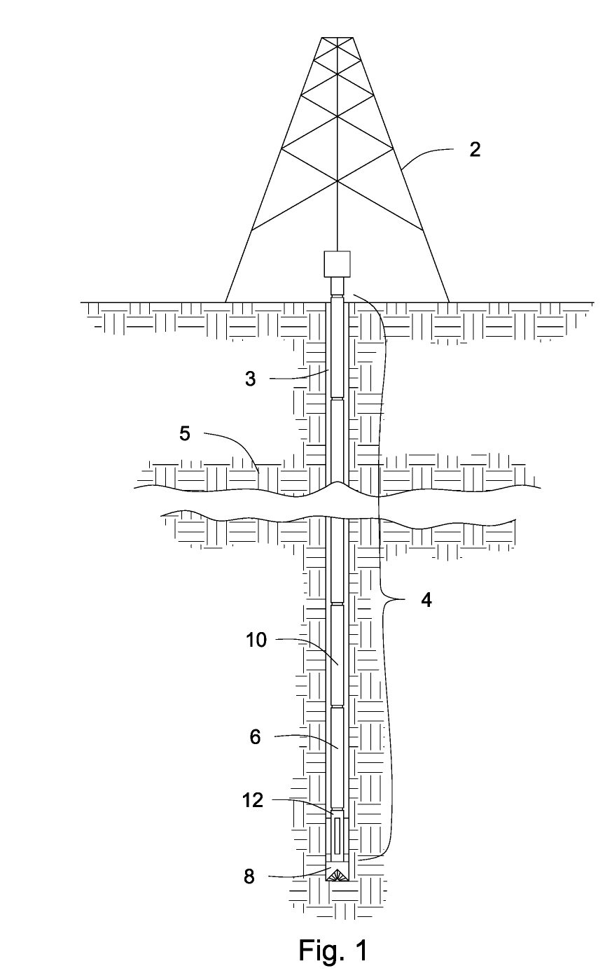

FIG. 1 is a cross section view of a drill rig 2 drilling a borehole 3 into the earth 5 using downhole components 6, 8, 10, 12 of the present invention. The collection of downhole components 6, 8, 10, 12 form a drill string 4. In operation, a drilling fluid is typically supplied under pressure at the drill rig 2 through the drill string 4. The drill string 4 is typically rotated by the drill rig 2 to turn a drill bit 8 which is loaded against the earth 5 to form the borehole 3. The pressurized drilling fluid is circulated through the drill bit 8 to provide a flushing action to carry the drilled earth cuttings to the surface. Rotation of the drill bit may alternately be provided by other downhole components such as drill motors, or drill turbines (not shown) located adjacent to the drill bit 8. Other downhole components include drill pipe 10 and downhole instrumentation such as logging while drilling tools 6, and sensor packages, (not shown). Other useful downhole components include stabilizers 12, hole openers, drill collars, heavyweight drill pipe, sub-assemblies, under-reamers, rotary steerable systems, drilling jars, and drilling shock absorbers which are all well known in the drilling industry. The downhole components 6, 8, 10, 12 may include a downhole tube 15 with an upset end 16 attached to a tool joint 30, 31. The following embodiments describe the various arrangements of the downhole component 6, 8, 10, 12 of present invention which have this construction to allow passage of the transmission line between the tool joint and the tube. As previously described, this construction is useful for electrical communication among the downhole components 6, 8, 10, 12 and the surface.

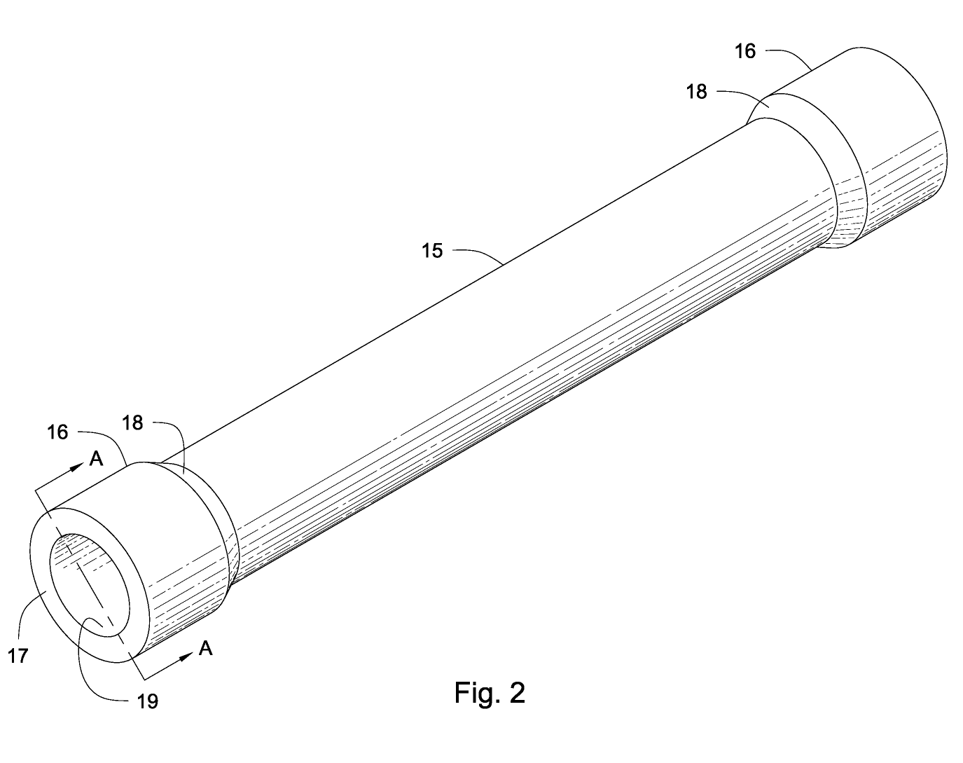

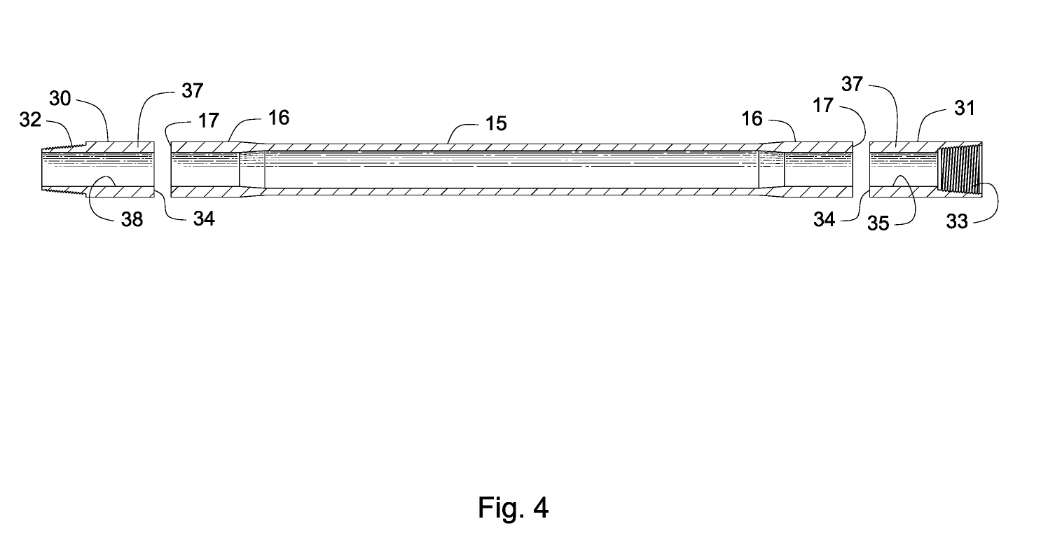

FIG. 2 is a perspective diagram of a downhole tube 15 comprising upset ends 16 formed on the ends of tube 15. The upset ends comprise an interfacial surface 17, a bore wall 19, and a transition surface 18. The effective inside diameter of the upset region adjacent the bore wall 19 is less than the inside diameter of the tube 15. Generally, the upset ends 16 have a wall thickness that is about one and one-half to twice that of the tube wall 15. The thickened wall of the upset provides an interfacial surface 17 suitable for attachment to the tool joint 30 and 31 as shown in FIG. 4. The downhole tube 15 is constrained to withstand the strain and torsional loads associated with the production of a subterranean bore hole. The effective diameter of the upset bore and bore wall interfacial surface 17 of the upset region are constrained to correspond to the matching bore and bore wall interfacial surface of the tool joint to which it is attached. In this application the interfacial surface of the tool joint will be referred to as the first interfacial surface and the interfacial surface of the upset end of the downhole tube will be referred to as the second interfacial surface, i.e. interfacial surface 17 is the second interfacial surface.

The downhole tube and tool joints are selected from the group of tools and make up a drill string for drilling oil, gas and geothermal wells, including, but not limited to drill pipe, heavyweight drill pipe, sub-assemblies, drill collars, drill bits, drill motors, logging while drilling tools, hole openers, stabilizers, under-reamers, rotary steerable systems, drilling jars, drilling shock absorbers, drilling turbines, sensor packages, and measuring while drilling tools.

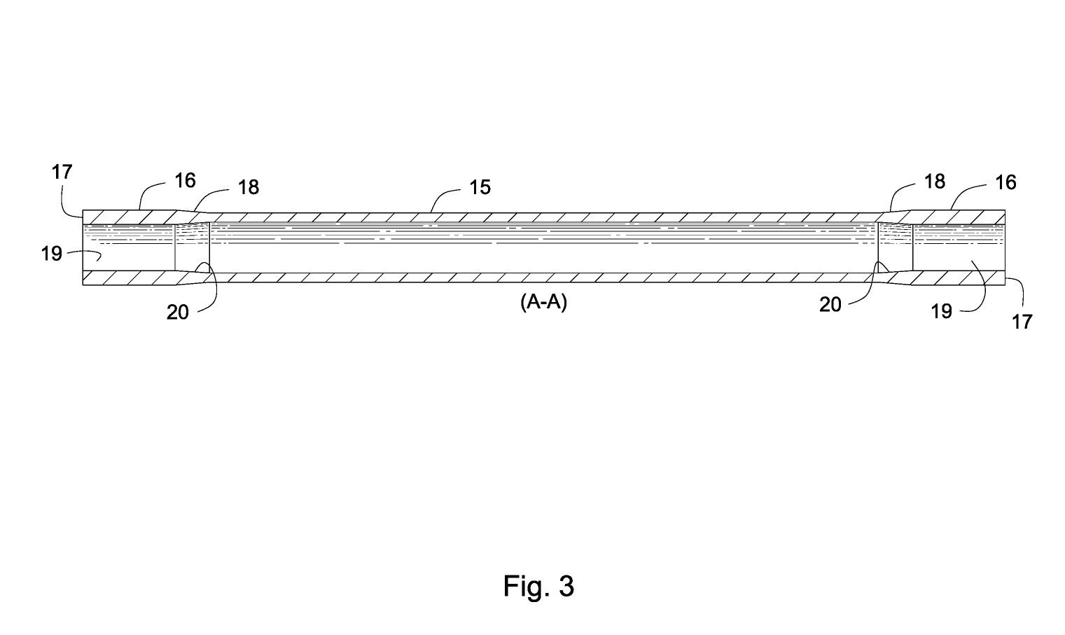

FIG. 3 is a cross-section diagram of FIG. 2 taken along line A-A. The cross section depicts in more detail the interior of the upset tube 15, the upset end portions 16, the second interfacial surface 17, the transition surface 18, and the bore wall 19 comprising the effective inside diameter of the upset 16, which is less than the diameter of the tube 15. Upset ends 16 are depicted having an external upset surface 18 and an internal upset surface 20 opposed to surface 18. The form of the upset ends is determined in relation to the grade and use of the downhole tube. In some cases, only an external upset is provided for in the tube end, while in others, as shown in FIG. 3, the ends are configured having both inside and external upset surfaces. The effective inside diameter of the upset bore is dimensioned to match the bore of the tool joint to which it will attached, thus provided a strong connection and a smooth hydraulic transition between the tool joint and the tube.

FIG. 4 is a cross-section diagram of downhole tube 15, as shown in FIG. 3, comprising upset ends 16 and depicting placement of elongate, generally cylindrical the tool joints 30 and 31 at the first and second interfacial surfaces 17 and 34, respectively. Tool joint 30 is a pin end tool joint having a wall 38 and external threads 32 for connection with an adjacent tool in the drill string. Tool joint 31 is a box end tool joint having internal threads 33, also for connection with an adjacent tool. The thickened wall of the upset 16 of the tube 15 corresponds with the bore walls 35 of the tool joints at the first interfacial surface 34 of the tool joints and with the second interfacial surface 17 of the tube 15. The preferred method of attached at the respective interfacial surfaces is by friction welding, spin welding, or inertial welding. This process produces a connection that is actually stronger than the tube 15, ensuring that if the tool were to twist off during the drilling operation it would do so along the tube wall rather than in the tool joint.

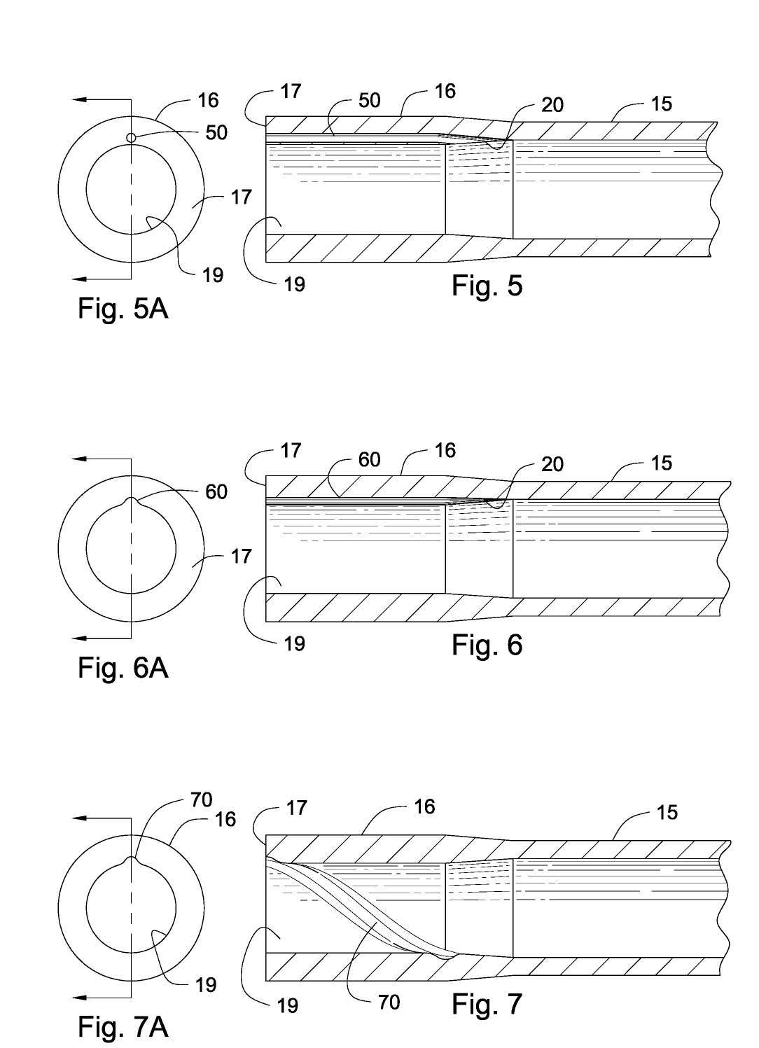

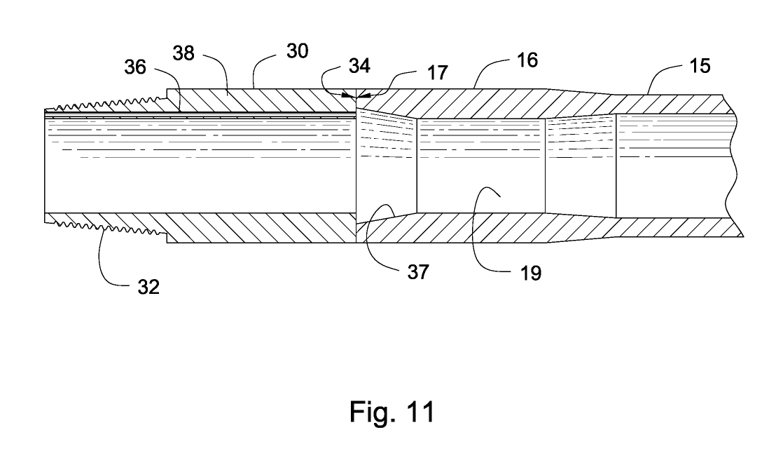

FIG. 5 is a cross-section diagram of an embodiment of the present invention depicting upset end 16 of tube 15 comprising an internal passageway 50. FIG. 5a is an end view of FIG. 5. Passageway 50 intersects the second interfacial surface 17 and the transition surface 20 of upset end 16. Upset 16 produces the internal bore wall 19 comprising the effective internal upset diameter which is less than the internal diameter of tube 15. Second interfacial surface 17 has a thickness greater than the wall thickness of tube 15 and corresponds to the thickness of the first interfacial surface of the tool joint to which it will be attached, as shown in FIG. 4 and FIG. 11. The upset end 16 is attached to a tool joint, say for example tool joint 30 or 31 of FIG. 4, in such a fashion that an opening 36 in the wall 38 of the tool joint, as shown in FIG. 11, in the tool joint will be aligned with the passageway 50. Although FIG. 11 depicts the pin end tool joint, a similar opening intersecting the first interfacial surface of the box end tool joint also applies. The alignment of the opening 10 in the tool joints with the passageway 50 in the upset ends allows for the passage of a transmission line from the tool joints through the upset tube 15 connecting transmission couplers in the respective tool joints with each other. The transmission line and the transmission couplers form a link in a downhole transmission network for transmitting power and data between downhole equipment and surface equipment. By forming the passageway in the tool joint and the upset end of the tube separately before joining the tool joint and the tube together, greater facility is achieved in manufacturing and the costs associated with forming the opening in the tool joint and the passageway in the upset portion of the tube are substantially reduced.

FIG. 6 is a cross-section diagram of another embodiment of the present invention depicting the tube and upset end of FIG. 5 comprising an external passageway 60. FIG. 6a is an end view of FIG. 6. The external passageway 60 comprises a rounded axial groove intersecting the second interfacial surface 17, the bore wall of the upset 19, and the upset transition surface 20. When the upset end 16 is attached to the tool joint, the opening 36 of FIG. 11 in the tool joint will be aligned with the passageway 60 in the upset end 16. The cooperation of the opening in the tool joint and the passageway in the upset end permits the passage of a transmission line from the tool joint to the tube 15.

FIG. 7 is a cross-section diagram of another embodiment of the present invention depicting the tube 15 and upset end 16 of FIG. 5 comprising a spiral passageway 70 across the upset end of the tube. FIG. 7a is an end view of FIG. 7. The spiral passageway 70 comprises a rounded groove intersecting the second interfacial surface 17, the bore wall of the upset 19, and the upset transition surface 20. When the upset end 16 is attached to the tool joint, an opening in the tool joint, like that described in FIG. 5, will be aligned with the passageway 70 in the upset end 16. The cooperation of the opening in the tool joint and the passageway in the upset end permits the passage of a transmission line from the tool joint to the tube 15.

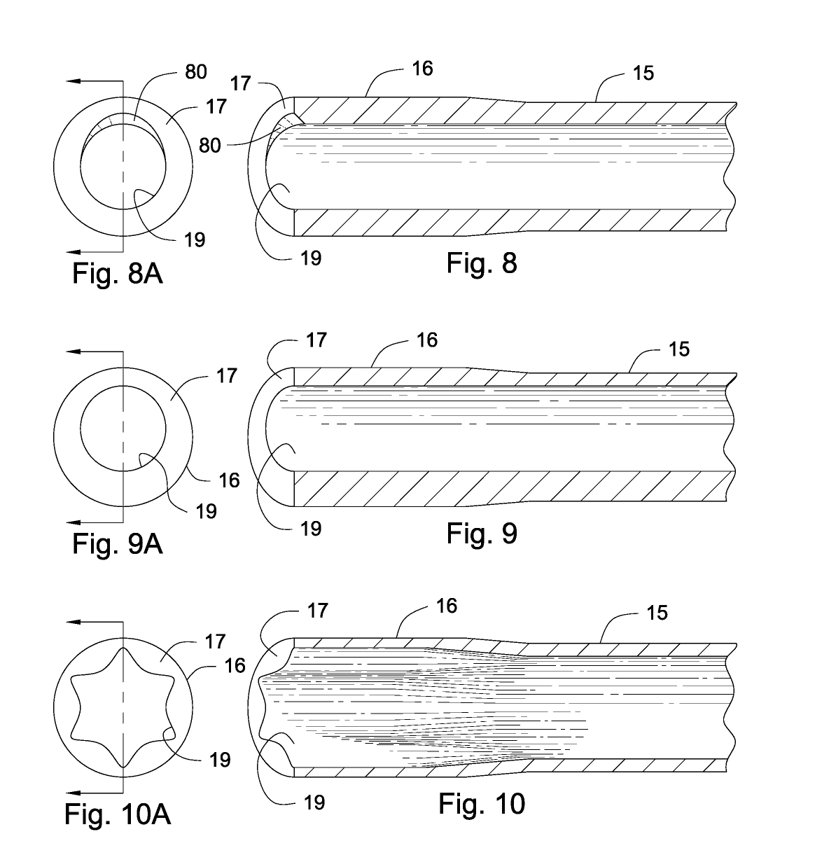

FIG. 8 is a cross-section diagram of another embodiment of the present invention depicting the tube and upset end of FIG. 5 comprising a circumferential groove or chamfer passageway 80 intersecting the second interfacial surface 17. FIG. 8a is an end view of FIG. 8. The passageway 80 comprises a circumferential groove or chamfer intersecting at least a portion of the second interfacial surface 17 and the bore wall of the upset 19. When the upset end 16 is attached to the tool joint, an opening like that described in FIG. 5 in the tool joint will be aligned with the passageway 80 in the upset end 16. The cooperation of the opening in the tool joint and the passageway in the upset end permits the passage of a transmission line from the tool joint to the tube 15.

FIG. 9 is a cross-section diagram of another embodiment of the present invention depicting the upset end and tube of FIG. 5 and comprising an eccentric wall thickness passageway. FIG. 9a is an end view of FIG. 9. The passageway is provided in the upset end by forming the effective inside diameter of the bore wall of the upset 19 eccentric from the longitudinal axis of the downhole tool. In this embodiment, the effective inside diameter is formed by the least radial distance from the axis of the tube 15 to the wall 19. When the tool joint is joined to the upset at the first and second interfacial surfaces, the opening like that described in FIG. 5 in the tool joint will be adjacent and aligned with region of the second interfacial surface having the least bore wall thickness at the second interfacial surface 17.

FIG. 10 is a cross-section diagram of another embodiment of the present invention depicting the upset end and tube of FIG. 5 and an upset comprising an upset bore wall 19 comprising a varying wall thickness passageway. FIG. 10a is an end view of FIG. 10. The passageway is provided in the upset end 16 by forming the effective inside diameter of the bore wall of the upset 19 with a varying wall thickness. Again, the effective inside diameter is formed by the least radial distance from the axis of the tube 15 to the wall 19. When the tool joint is joined to the upset at the first and second interfacial surfaces, the opening of FIG. 5 in the tool joint at the first interfacial surface will be adjacent and aligned with the region of the second interfacial surface 17 having the least bore wall thickness at the second interfacial surface 17. In this manner, a transmission line will pass from the tool joint through the downhole tube 15 joining transmission couplers located in the tool joints.

FIG. 11 is a cross-section diagram of an embodiment of the present invention depicting an upset end 16, the downhole tube 15, and the tool joint 30. The tool joint 30 comprises threads 32 and a wall 38 and is attached to the upset end of tube 15 at their respective interfacial surfaces 34 and 17. An opening 36 in the wall 38 is provided through the tool joint 30 that intersects the first interfacial surface 34. A passageway 37 is provided in the upset portion 16 of the tube 15. The passageway intersects the interfacial surface 17 and the upset bore wall 19 of the downhole component. The passageway 37 comprises a bore wall thickness at the second interfacial surface 17 that is less than bore wall thickness of the tool joint 30 at the first interfacial surface 34. The difference in the thickness of the respective wall thicknesses produces the passageway 37 through which a transmission line may pass from the tool joint 30 to downhole tube 15.

1. A downhole component, comprising:
a tube having an inside diameter and an elongate, generally cylindrical tool joint comprising a first interfacial surface and having a wall;
an upset formed on an end of the tube comprising a second interfacial surface and having an effective inside diameter less than the inside diameter of the tube;
the tool joint being attached to the upset on the tube at the first and second interfacial surfaces and an opening formed within the wall of the tool joint in alignment with a passageway formed in the upset;
wherein the opening and the passageway allow passage of a transmission line between the tool joint and the tube.

2. The downhole component of claim 1, wherein the passageway formed in the upset is provided by varying a thickness of the upset.

3. The downhole component of claim 1, wherein the passageway formed in the upset is provided by forming the effective inside diameter of the upset eccentric from a longitudinal axis of the tool joint.

4. The downhole tube of claim 1, wherein the passageway formed in the upset is provided by at least a portion of the upset having a thickness that is less than the tool joint bore wall thickness at the first and second interfacial surfaces between the tool joint and the upset.

5. The downhole component of claim 1, wherein the passageway formed in the upset comprises a circumferential chamfer in at least a portion of the upset.

6. The downhole component of claim 1, wherein the passageway formed in the upset comprises a circumferential groove in a least a portion of the upset.

7. The downhole component of claim 1, wherein the passageway formed in the upset comprises a spiral groove in the upset.

8. The downhole component of claim 1, wherein the passageway formed in the upset comprises an axial groove in at least a portion of the upset.

9. The downhole component of claim 1, wherein the passageway formed in the upset comprises an internal passageway intersecting the second interfacial surface and a transition surface of the upset.

10. The downhole component of claim 1, wherein the passageway formed in the upset comprises one or more external passageways intersecting at the second interfacial surface and a transition surface of the upset.

11. The downhole component of claim 1, wherein the tube and the tool joint are joined at the first and second interfacial surfaces by friction welding.

12. The downhole component of claim 1, wherein when the tool joint is welded to the tube, the passageway and the opening are sufficiently aligned to allow passage of a transmission line between the tool joint and the downhole tool.

13. The downhole component of claim 1, wherein the passageway formed in the upset allows passage of a transmission line that is in communication with a transmission coupler located in the tool joint and is part of a downhole network for electrical transmission between downhole equipment and surface equipment.

14. The downhole component of claim 1, wherein the component is selected from the group consisting of drill pipe, heavyweight drill pipe, sub-assemblies, and drill collars.

15. The downhole component of claim 1, wherein the component is selected form the group consisting of drill bits, drill motors, logging while drilling tools, hole openers, stabilizers, under-reamers, rotary steerable systems, drilling jars, drilling shock absorbers, drilling turbines, sensor packages, and measuring while drilling tools.

16. A downhole component comprising a tube with at least one passageway formed in an upset that cooperates with an opening in a tool joint such that when the tube and the tool joint are joined together, the passageway in the tube and the opening in the tool joint allow the passage of a transmission line from the tool joint to the tube.
